(19) United States
(12) Patent Application Publication
(10) Pub. No.: US 2016/0212273 A1
(43) Pub. Date: Jul. 21, 2016

(54) SYSTEMS AND METHODS FOR DISTRIBUTED AUDIO CONFERENCING

(71) Applicant: Wyde Voice, LLC, Long Beach, CA (US)

(72) Inventors: Evgeny Tsypnyatov, Gaithersburg, MD (US); Anatoliy Kachan, Chernihiv (UA)

(21) Appl. No.: 14/991,941

(22) Filed: Jan. 9, 2016

Related U.S. Application Data
(60) Provisional application No. 62/106,196, filed on Jan. 21, 2015.

(51) Int. Cl. H04M 3/56

(52) U.S. Cl. CPC H04M 3/568

(57) ABSTRACT

Methods, systems, means and machine-readable media embodying program instructions for geo-distributed teleconferencing by carrying out a teleconference using a plurality of regional bridges that each connect with a different group of callers, where one of the regional bridges is selected as a master bridge that operates differently than the other bridges.

### RELATED APPLICATIONS

This application relates to U.S. patent application Ser. No. 62/106,196, filed Jan. 21, 2015, entitled SYSTEMS AND METHODS FOR DISTRIBUTED AUDIO CONFERENCING, the content of which is hereby incorporated by reference herein in its entirety.

### FIELD

Various embodiments relate to teleconferencing, and more particularly, to systems, methods and machine-readable media for carrying out a teleconference using a plurality of geo-distributed bridges.

### BACKGROUND

Systems and methods for connecting people—e.g., telephone calls, emails and other means of communication—must keep up with the global nature of relationships among people. In audio conferencing, for example, is important to connect participants from different countries to the same teleconference; however, it is also critical to do so while efficiently managing resources and minimizing the effect of regional technical issues during a teleconference. Clearly, systems and methods that solve the above problems are needed. Fortunately, such solutions are presented below.

### SUMMARY

Certain embodiments of this disclosure relate generally to systems (e.g., networks, devices, or device components), methods and machine-readable media for teleconferencing users in different geographic regions. Such systems, methods and machine-readable media may: receive, at a first regional bridge, a first call from a first user after the first user dials a first regional phone number, wherein the first regional bridge identifies a teleconference based on input from the first user; receive, at a second regional bridge, a second call from a second user after the second user dials a second regional phone number, wherein the second regional bridge identifies the teleconference based on input from the second user; and form a communication channel between the first regional bridge and the second regional bridge that permits the first regional bridge and the second regional bridge to collectively host the teleconference, wherein the communication channel exchanges first audio output and first meta data from the first regional bridge to the second regional bridge, and wherein the communication channel exchanges second audio output and second meta data from the second regional bridge to the first regional bridge.

Certain embodiments of this disclosure relate generally to a teleconferencing system that comprises: a plurality of bridges that collectively host a teleconference, wherein the plurality of bridges includes at least a first bridge connected to a first caller of the teleconference and a second bridge connected to a second caller of the teleconference.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1A depicts aspects of a system for audio conferencing using one bridge.

FIG. 1B depicts aspects of a system for distributed audio conferencing using multiple bridges.

FIG. 2 depicts aspects of a system for distributed audio conferencing using two bridges.

FIG. 3 illustrates a process for distributed audio conferencing using two bridges.

FIG. 4A through FIG. 4C each depict a system for distributed audio conferencing using a different one of three bridges as a master bridge.

FIG. 5 illustrates a process for distributed audio conferencing using a selected bridge from among other bridges as a master bridge.

FIG. 6A through FIG. 6C depict three time periods during which each of two bridges are designated as the master bridge for an audio conference.

FIG. 7 illustrates a process for selecting different bridges as the master bridge of an audio conference at different times during the audio conference.

FIG. 8 depicts a bridge system for geo-distributed conferencing.

FIG. 9 depicts a network of bridges for geo-distributed conferencing.

Like reference numbers and designations in the drawings indicate like elements.

### DETAILED DESCRIPTION

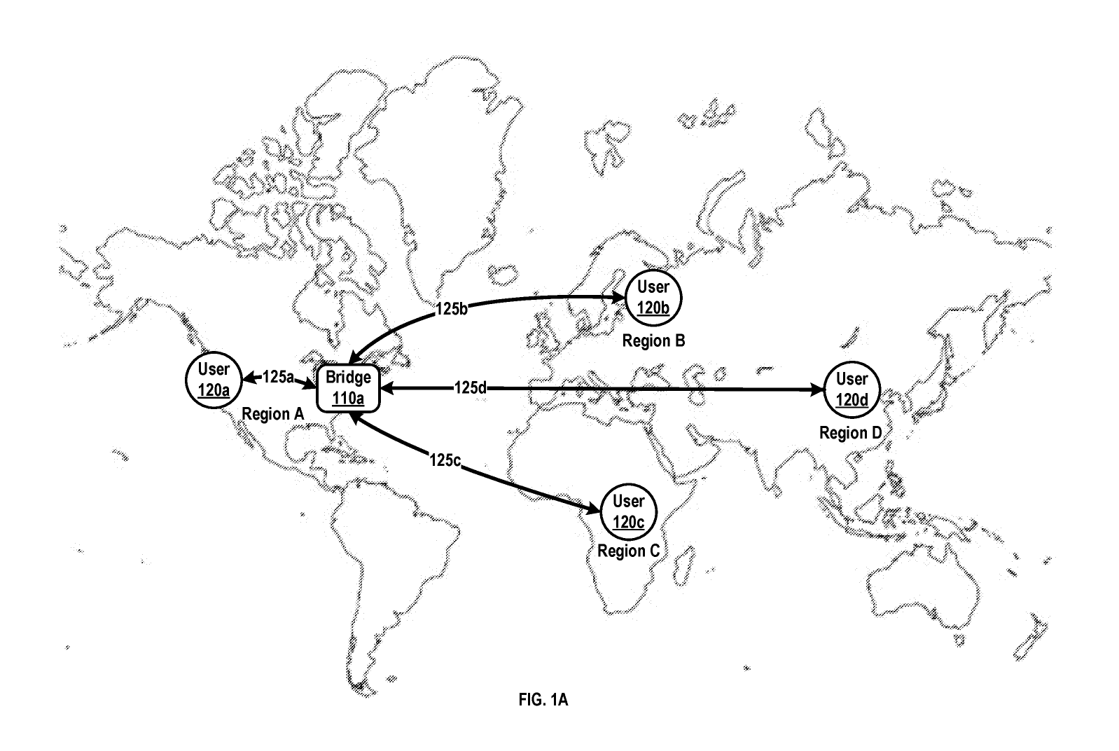

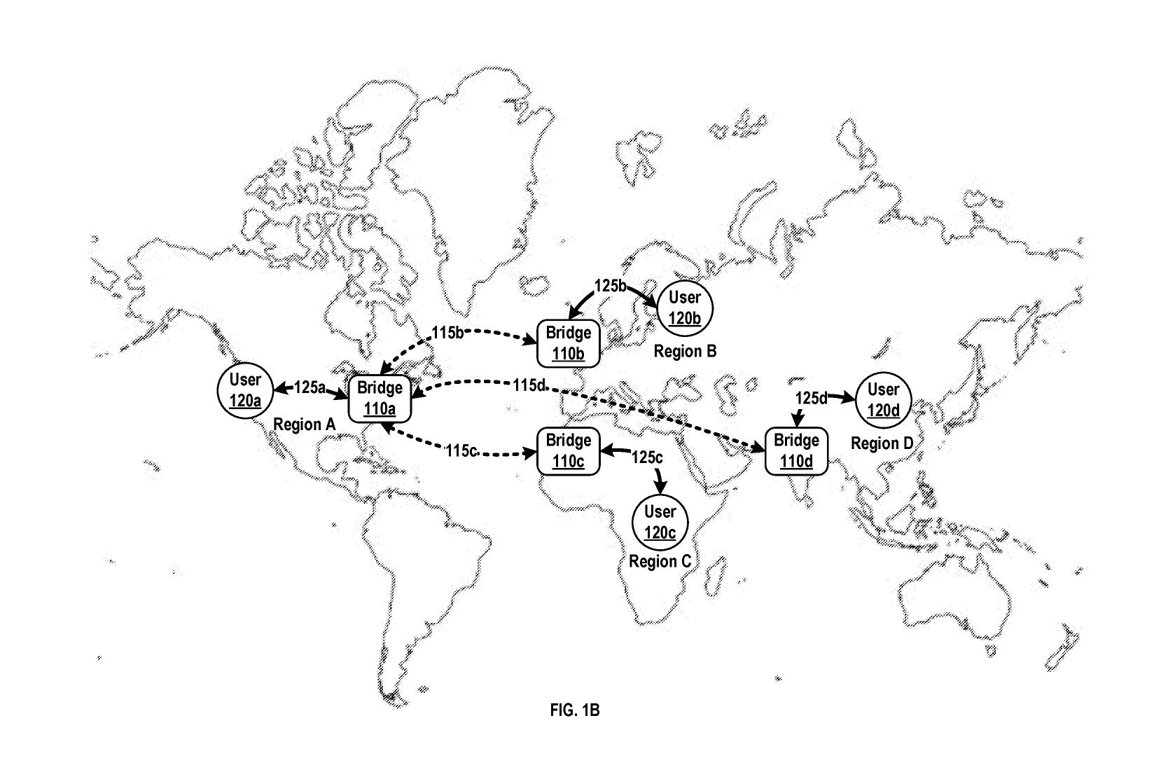

FIG. 1A depicts aspects of a system for audio conferencing using one bridge. The system is shown to include Regions A through D, within which users 120a through 120d join the same conference call that is managed by a bridge 110a in Region A by making connections 125a through 125d with the bridge 110a. The connections 125a through 125d are made by typical means—e.g., by calling the same phone number designated for the conference call, where the region code (e.g., country code) for Region A is dialed by the users 120b through 120d of Regions B through D, or where callers in the same region call different numbers that are forwarded to the same location.

FIG. 1B depicts aspects of a system for distributed audio conferencing using multiple bridges. The system is shown to include the Regions A through D, within which the users 120a through 120d join the same conference call that is collectively managed by bridges 110a through 110d in each of the Regions A through D. Unlike the users 120a through 120d in the system of FIG. 1A, who made connections 125a through 125d with only the bridge 110a, the users 120a through 120d in the system of FIG. 1B make connections 125a through 125d with the bridges 110a through 110d, respectively. The connections 125a through 125d are made by calling different regional phone numbers that are all designated for the conference call. As shown, bridges 110b through 110d each make a different connection 115b through 115d with the bridge 110a.

Notably, aspects depicted in FIG. 1B relate to mixing sets of calls on multiple bridges instead of mixing all sets of calls on a single bridge, which is depicted in FIG. 1A. In one embodiment, users can choose the bridge where that user's call will be mixed by dialing a specific telephone number. If a software client is used to make a user's call, software client can automatically determine the most suitable bridge, which is usually the closest bridge relative to the position of the origin of the user's call. A bridge may mix a set of calls from a set of users by receiving inputs from each user, and passing the inputs through some algorithm that produces a single output. This output is sent back to every user (e.g., usually with a small modification that removes a particular user's input from the output). Multiple bridges that are collectively hosting the same teleconference may then automatically decide how to connect to each other in order to link individual groups of users into one virtual conference so all users who dialed to the different bridges can have a conversation. Bridges in a network monitor each other's status so they each know if there are calls in progress on particular bridges in relation to particular teleconferences. Groups of bridges are selected to collectively host a teleconference based on this information.

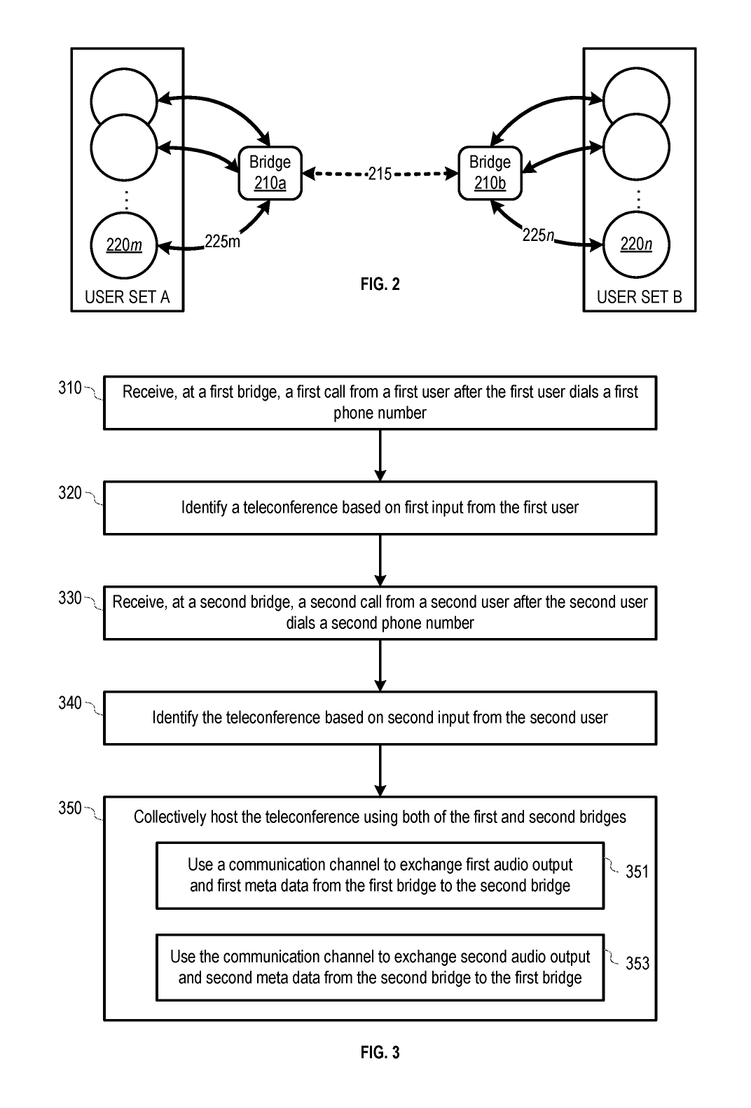

FIG. 2 depicts aspects of a system for distributed audio conferencing using two bridges. As shown, two bridges 210a and 210b make a connection 215 such that the two bridges 210a and 210b connect different sets of users A and B to the same conference call. Each of the user sets A and B may include a different number of users. For example, the user set A includes a first number of users up to a user 220m, and the user set B includes a second number of users up to a user 220n, where m and n can be any number greater than zero.

FIG. 3 illustrates a process for distributed audio conferencing using two bridges. As shown, a first bridge receives a first call from a first user after the first user dials a first phone number (310), and a teleconference is identified based on first input from the first user (320). A second bridge receives a second call from a second user after the second user dials a second phone number (330), and the teleconference is identified based on second input from the second user (340). Collectively, the first and second bridges host the teleconference (350) by using a communication channel to exchange first audio output and first meta data from the first bridge to the second bridge (351), and using the communication channel to exchange second audio output and second meta data from the second bridge to the first bridge (352).

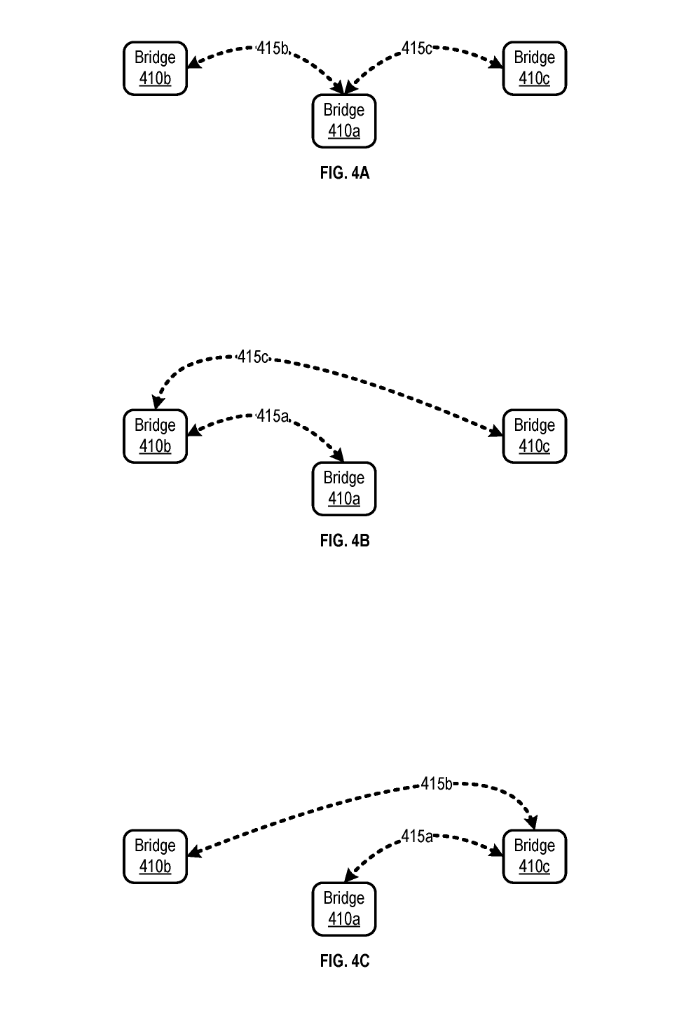

FIG. 4A through FIG. 4C each depict a system for distributed audio conferencing using a different one of three bridges 410a through 410c as a master bridge. A master bridge receives information (e.g., metadata) a bridge and broadcasts that information to other bridges who did not receive it from that bridge. In one embodiment, the master bridge is in charge of keeping the state of the conference (e.g., recording, group mute, Q&A, etc.) synchronized across all bridges participating in the conference. It becomes especially important in scenarios after a temporal network interruption has occurred. The master bridge also resolves conflicts where other bridges get conflicting states.

As shown in FIG. 4A, the bridge 410a is the master bridge (where the bridges 410b and 410c connect to the bridge 410a via connections 415b and 415c); as shown in FIG. 4B, the bridge 410b is the master bridge (where the bridges 410a and 410c connect to the bridge 410b via connections 415a and 415c); and as shown in FIG. 4C, the bridge 410c is the master bridge (where the bridges 410a and 410b connect to the bridge 410c via connections 415a and 415b).

FIG. 4A through FIG. 4C may be interpreted as depicting different conference calls, where the bridge 410a is selected as the master bridge for a first conference call depicted by FIG. 4A, where the bridge 410b is selected as the master bridge for a second conference call depicted by FIG. 4B, and where the bridge 410c is selected as the master bridge for a third conference call depicted by FIG. 4C.

Alternatively, FIG. 4A through FIG. 4C may be interpreted as depicting different options for a master node of the same conference call, where the bridge 410a is selected as the master bridge in FIG. 4A, where the bridge 410b is selected as the master bridge in FIG. 4B, and where the bridge 410c is selected as the master bridge in FIG. 4C.

Selection of a bridge as a master bridge may be based on the relative locations of the bridges to each other. In one embodiment, the selection of a first bridge as a master bridge occurs when the first bridge is the most centrally located bridge relative to all of the bridges of a teleconference. In another embodiment, the selection of a first bridge as a master bridge occurs when the first bridge resides in a region that is preferred over other regions.

Alternatively, selection of a bridge as a master bridge may be based on one or more values of one or more different operating parameters for each of the bridges. In one embodiment, the selection of a first bridge as a master bridge occurs when a value of an operating parameter for the first bridge meets a threshold condition (e.g., falls below or exceeds a predefined value; e.g., is preferred over each value of the operating parameter for other bridges).

By way of example, operating parameters may include: latencies between the bridge and other bridges (where a bridge with the lowest latencies or latencies below a minimum level of latency may be favored as a master bridge); the size of the data center within which the bridge resides (where a bridge in the largest data center or in a data center with at least a minimum size may be favored as a master bridge); the region within which the bridge resides (where a bridge in a region with preferred or a minimum level of economic or infrastructure conditions may be favored as the master bridge); the connectivity quality of a bridge (where a bridge with the best connectivity or connectivity exceeding a minimum level of connectivity may be favored as a master bridge); the available bandwidth a bridge (where a bridge with the most available bandwidth or available bandwidth exceeding a minimum level of available bandwidth may be favored as a master bridge); a number of users directly connected to the bridge (where a bridge with the most users or a number of users exceeding a minimum level of users may be favored as a master bridge); or a weighted combination of any number of the preceding parameters.

Alternatively, FIG. 4A through FIG. 4C may be interpreted as depicting the same conference call during three different time periods, where the bridge 410a is selected as the master bridge for a first time period depicted by FIG. 4A, where the bridge 410b is selected as the master bridge for a second time period depicted by FIG. 4B, and where the bridge 410c is selected as the master bridge for a third time period depicted by FIG. 4C.

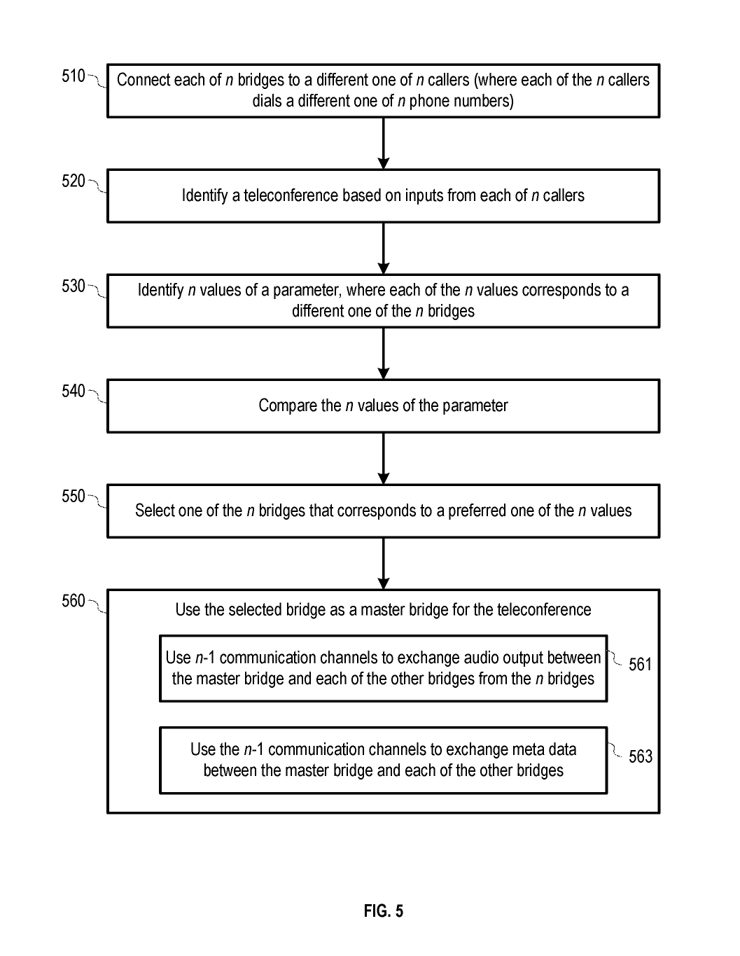

FIG. 5 illustrates a process for distributed audio conferencing using a selected bridge from among other bridges as a master bridge. As shown, each of n bridges connects to a different one of n callers (where each of the n callers dials a different one of n phone numbers) (510). The same teleconference is identified based on inputs from each of n callers (520). Then, n values of a parameter are identifies, where each of the n values corresponds to a different one of the n bridges (530). The n values of the parameter are compared (540), and one of the n bridges that corresponds to a preferred one of the n values is selected (550). The selected bridge is used as a master bridge for the teleconference (560). After the selection of the master bridge, n−1 communication channels are used to exchange audio output between the master bridge and each of the other bridges from the n bridges (561), and also to exchange meta data between the master bridge and each of the other bridges (562).

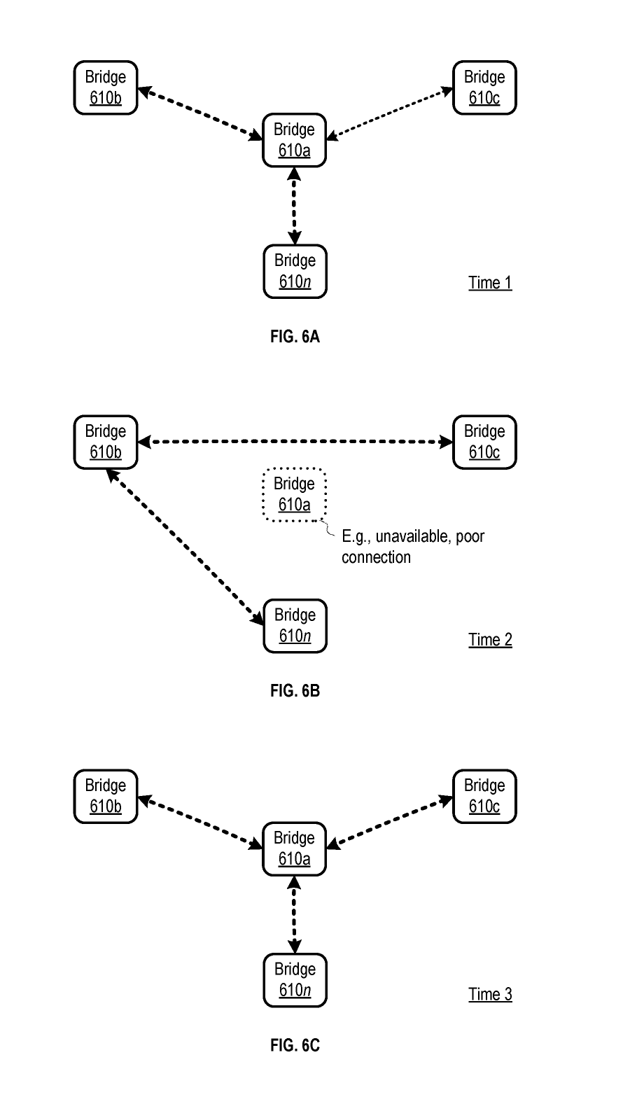

FIG. 6A through FIG. 6C depict three time periods during which each of two bridges 610a and 610b are designated as the master bridge for an audio conference depending on whether the bridge 610a is available during each of the three time periods. As shown in FIG. 6A, the bridge 610a is selected as the master bridge; as shown in FIG. 6B, the bridge 610b is selected as the master bridge; and as shown in FIG. 6C, the bridge 610c is selected as the master bridge.

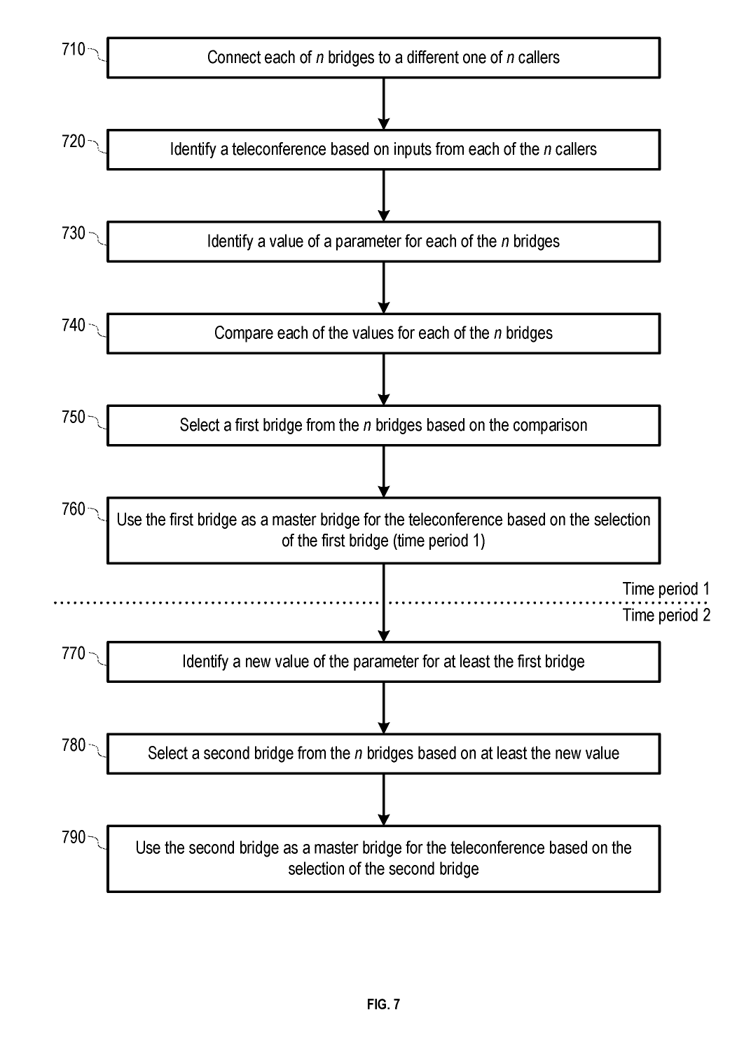

FIG. 7 illustrates a process for selecting a bridge from among different bridges to be the master bridge of an audio conference at different times during the audio conference.

During a first time period, each of n bridges connects to a different one of n callers (710), and the same teleconference is identified based on inputs from each of the n callers (720). A value of a parameter for each of the n bridges is identified (730), and the resulting values are compared (740). A first bridge is then selected from the n bridges based on the comparison (750), and the first bridge is used as a master bridge for the teleconference based on the selection of the first bridge (760).

During a second time period, a new value of the parameter for at least the first bridge is identified (770), and a second bridge from the n bridges is selected based on at least the new value (780). The second bridge is then used as the master bridge for the teleconference based on the selection of the second bridge (790).

### Advantages of Methodologies

Practice of the methods disclosed herein offer many advantages over predecessor approaches, including: better quality by implementing certain embodiments that do not forward calls over long distances, which avoids excessive delays, big jitter and packet loss; cost reduction by implementing certain embodiments that do not forward calls, which avoids expensive long distance and other fees associated with long distance forwarding of calls or simultaneously forwarding of calls to guarantee good quality like when forwarding over PSTN; better scalability by implementing certain embodiments that avoid limits on the size of a teleconference associated with a maximum capacity of a carrier associated with a single bridge by offsetting some of the capacity from the carrier to another carrier associated with another bridge (e.g., X calls from X users to a single bridge that are impossible to carry over a pipeline that is only capable of handling less than X calls can be split between two pipeline to two bridges); enhanced reliability by implementing certain embodiments that minimize the impact of changing network quality (e.g., network interruptions) because bridges need only communicate with each other only if needed; providing enhanced computer operations that would otherwise be unavailable without practicing the methods disclosed herein; and permitting two or more computing devices to interact with each other in various ways that are not possible without practicing the methods disclosed herein.

### Additional Features

In various embodiments described above, multiple regional bridges exchange inputs and outputs to form a single teleconference. Rules may be followed to control how bridges connect to each other, where each bridges transmits its output, and from where each bridge receives input. In at least one embodiment, a master bridge receives the outputs from other bridges, but those other bridges do not send their outputs to each other (e.g., to avoid feedback from loops, and latency issues from chained bridges); however, each of the bridges are independent, self-sufficient bridges that can provide service for their regional users even if they are totally disconnected from the other bridges. In at least one embodiment, a master bridge need not be present all the time such that two or more regional bridges may connect directly with each other to form a virtual conference. Also, different bridges may operate as the master bridge for a conference call at different times.

Attendee list embodiment: Bridges may connect to each other to exchange meta information about a teleconference, including a bridge's attendee list is used to update a global attendee list as users connect with the bridge. Thus, every bridge participating in the teleconference can access a global list of all participants even when all of the participants are not connected to that bridge.

Active speaker embodiment: As information is transferred together with the audio output from one bridge to another, an active speaker is identified so every bridge participating in the conference knows who is currently speaking even if the active speaker is not connected to that bridge.

Conference-wide settings embodiment: Conference-wide settings (e.g., mute, record, hold, Q&A, others) initiated at a bridge may be removed when it is detected that the bridge is disconnected from other bridges. Alternatively, the settings may be maintained, but control over them may be transferred to another bridge that is still connected to the teleconference. This can be accomplished without requiring an instruction from that disconnected bridge to remove the setting, which allows other bridges that are still connected to continue the teleconference while that bridge is disconnected.

In at least one embodiment, each bridge periodically collects and provides the following information: conference identifiers of teleconferences on that bridge; an attendee list of attendees for each of the teleconferences; status of settings (e.g., mute, hold, recording, etc.) for each of the teleconferences; a call detail record (CDR); and others. This data may be stored and distributed to other bridges. Each bridge knows the list of peer bridges with whom it potentially needs to communicate, and the bridges periodically ping each other to reveal availability, network quality and a weight of every individual bridge, where this information is used when bridges need to connect to each other.

Establishing a teleconference between or among bridges in one embodiment: When a user calls in to Bridge A, Bridge A identifies a teleconference number, and creates new instance of the teleconference if that teleconference is not yet running on Bridge A. Bridge A may also create a conference identifier associated with the teleconference number, both of which may be sent as a “new teleconference” message to other Bridges B through. When Bridge B receives the new teleconference message, Bridge B checks if the teleconference associated with the teleconference number is already running on Bridge B. If the teleconference is running, Bridges A and B create a span channel, over which voice and meta data (e.g., attendee list, active speaker, settings, channel statuses) may be exchanged between Bridges A and B. If Bridges B and C were already connected (e.g., via a span channel) to each over for this particular teleconference, the appearance of Bridge A does not necessarily cause both Bridges B and C to each establish a connection to Bridge A unless it is determined that Bridge A should be a master bridge. If either Bridge B or Bridge C are the master bridge, that master bridge initiates a span channel to Bridge A. If Bridge B or C was the master bridge, and Bridge A is selected to be the master bridge, then span channels between Bridge B or C and other bridges are replaced by span channels between Bridge A and those other bridges. When all calls are gone from a particular bridge, that bridge is removed from the teleconference, which may require selection of a new master bridge. Determining which of the Bridges A, B or C should be the master bridge may be accomplished via different ways, including the following graph theory embodiment below and other approaches for selecting a master bridge described elsewhere herein (e.g., the approaches described above in association with the figures). In one implementation, all the bridges are connected in a “star” topology.

Connecting multiple bridges using graph theory embodiment: Graph theory algorithms (e.g., a spanning tree algorithm) may be used to determine how multiple bridges connect to each other so long as the bridges can communication with each other. Upon detecting a new bridge for a teleconference that already includes bridges, an new connections among those bridges may be made to minimize interruptions, latency, other potential issues, and/or the diameter of a spanning graph that takes into consideration characteristics of the bridges (e.g., location, connectivity, availability and/or a weight of each bridge, where the weight may be assigned based on the capacity, reliability and available bandwidth of each bridge or its datacenter).

Using two or more master bridges embodiment: It is possible to use multiple master bridges, each for a different sub-set of all bridges in a teleconference. The master bridges may then communicate with each other (e.g., to exchange information, or to determine which bridge will become the only master bridge). In one embodiment, a “supreme” master bridge may become a master bridge of the master bridges to carry out the teleconference, which may be needed where some bridges cannot see the supreme master bridge. In some cases, technical issues prevent the multiple master bridges from communicating with each other, which results in multiple simultaneous instances of the teleconference for multiple groups of callers (e.g., people who called a first set of bridges are not able to interact with people who called a second set of bridges). This may be necessary until the instances of the teleconference are merged into a single instance again (e.g., people who called the first set of bridges are able to interact with people who called the second set of bridges).

The attendee list may include: the dialed number; the dialing number a caller ID, a call start time; a media description; and equipment description; and a call state (mute/hold). A conference state may include: a group mute indicator; a group hold indicator; a recording on/off indicator; a conference policy. Commands sent by a bridge to control state of the other bridge may include: drop attendee; start/stop recording; and perform group operation (Mute/Hold/Q&A).

### Example of System for Geo-Distributed Conferencing

In at least one embodiment, a geo-distributed cluster consists of a number of bridges (e.g., where each bridge includes similar components like those discussed below). Each bridge is capable of operating on its own and does not require any supervision from an external entity. However, when there is a need to form a geo-distributed conference, the bridges can automatically arrange into a group.

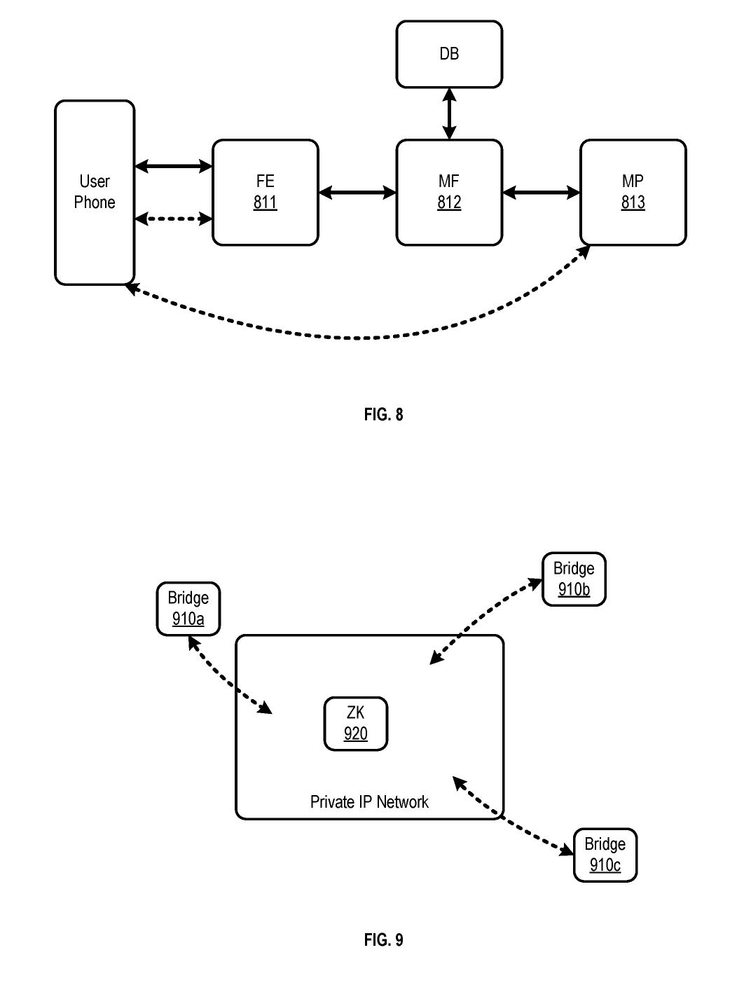

FIG. 8 depicts a bridge system for geo-distributed conferencing, which includes the following components, where solid lines designate signaling traffic (e.g., meta information), and dotted lines designate audio traffic (e.g., RTP).

FE (811): This component is responsible for receiving a call and passing it through the interactive voice response (IVR) to let a user enter conference information (e.g., an access code). When a call is already in the conference, this component plays announcements and provides an in-conference IVR for every call.

MF (812): This is a core component that analyzes user input and other parameters to identify a conference into which a particular call is placed. It also maintains conference statuses (mute, hold, recording, Q&A, etc.) and orchestrates other components so they work together. The MF (812) does not process any media traffic. It only deals with the signaling/controlling streams. The MF (812) knows what conferences are running on the bridge, and is in charge of managing connections of the bridge.

MP (813): This component is in charge of mixing media in an appropriate conference. The MP (813) creates and deletes a conference, and mixes calls per specific commands from the MF (812).

FIG. 9 depicts a network of bridges for geo-distributed conferencing with three standalone bridges (910a-c) connected into a private IP network to from a distributed cluster with the following component.

ZK (920): This component can be viewed as a lightweight network database that guarantees consistency and high availability of stored information. The purpose of this component is to store states of all conferences that run on all bridges (910a-c) in the cluster. It is similar to the MF (812) in a standalone bridge shown in FIG. 8. While the MF (812) keeps track of local conferences on that bridge, the ZK (920) keeps track of distributed conferences in the cluster.

Every bridge in FIG. 9 writes information about its conferences into the ZK (920), and reads information about conferences on other bridges from the ZK (920). If it turns out that the conference has to be connected, every bridge (910a, 910b, 910c) employs algorithms to select a master bridge and establish a spanning link.

Other Aspects Related to Systems & Methods

Functionality and operation disclosed herein may be embodied as one or more methods implemented, in whole or in part, by machine(s)—e.g., computing component(s) like processor(s), computers, or other suitable means known in the art—at one or more locations, which enhances the functionality of those machines, as well as computing devices that incorporate those machines. Non-transitory machine-readable media embodying program instructions adapted to be executed to implement the method(s) are also contemplated. Execution of the program instructions by one or more computing components cause the computing components to carry out the method(s). Systems (e.g., apparatuses or components thereof) operable to implement the method(s) are also contemplated.

It is noted that method steps described herein may be order independent, and can therefore be performed in an order different from that described. It is also noted that different method steps described herein can be combined to form any number of methods, as would be understood by one of skill in the art. It is further noted that any two or more steps described herein may be performed at the same time. Any method step or feature disclosed herein may be expressly restricted from a claim for various reasons like achieving reduced manufacturing costs, lower power consumption, and increased processing efficiency.

By way of example, not by way of limitation, method(s) and computing component(s) or other means may: receive, at a first regional bridge, a first call from a first user after the first user dials a first regional phone number, wherein the first regional bridge identifies a teleconference based on input from the first user; receive, at a second regional bridge, a second call from a second user after the second user dials a second regional phone number, wherein the second regional bridge identifies the teleconference based on input from the second user; and form a communication channel between the first regional bridge and the second regional bridge that permits the first regional bridge and the second regional bridge to collectively host the teleconference, wherein the communication channel exchanges first audio output and first meta data from the first regional bridge to the second regional bridge, and wherein the communication channel exchanges second audio output and second meta data from the second regional bridge to the first regional bridge.

In accordance with some aspects, the first regional bridge and the second region bridge are in different geographical regions.

Method(s) and computing component(s) or other means may further or alternatively: designate the first regional bridge as the master node when a first capacity of the first regional bridge is better than a second capacity of the second regional bridge, a first available bandwidth of the first regional bridge is better than a second available bandwidth of the second regional bridge, and/or a first reliability measurement of the first regional bridge is better than a second reliability measurement of the second regional bridge.

Method(s) and computing component(s) or other means may further or alternatively: designate the second regional bridge as the master node when a second capacity of the second regional bridge is better than a first capacity of the first regional bridge, a second available bandwidth of the second regional bridge is better than a first available bandwidth of the first regional bridge, and/or a second reliability measurement of the second regional bridge is better than a first reliability measurement of the first regional bridge.

Method(s) and computing component(s) or other means may further or alternatively: receive, at a third regional bridge, a third call from a third user who uses a third regional phone number, wherein the third regional bridge identifies the conference identifier based on input from the third user that identifies the conference identifier; and form an additional communication channel between the third regional bridge and only a selected one of the first and second regional bridges, wherein the additional communication channel exchanges third audio output and third meta data from the third regional bridge to the selected one of the first and second regional bridges, and wherein the additional communication channel exchanges the first and second audio output and the first and second meta data from the selected one of the first and second regional bridges to the third regional bridge.

Method(s) and computing component(s) or other means may further or alternatively: designate one of the first, second and third regional bridges as a master node in order to minimize latency of data exchange among the first, second and third bridges.

Method(s) and computing component(s) or other means may further or alternatively: designate one of the first, second and third regional bridges as a master node in order to minimize a diameter of a spanning graph based on consideration of the locations of the first, second and third bridges.

Method(s) and computing component(s) or other means may further or alternatively: designate the first regional bridge as the master node when a first capacity of the first regional bridge is better than a second capacity of the second regional bridge and a third capacity of the third regional bridge, a first available bandwidth of the first regional bridge is better than a second available bandwidth of the second regional bridge a third available bandwidth of the third regional bridge, and/or a first reliability measurement of the first regional bridge is better than a second reliability measurement of the second regional bridge a third reliability measurement of the third regional bridge.

Method(s) and computing component(s) or other means may further or alternatively: designate the second regional bridge as the master node when a second capacity of the second regional bridge is better than a first capacity of the first regional bridge and a third capacity of the third regional bridge, a second available bandwidth of the second regional bridge is better than a first available bandwidth of the first regional bridge a third available bandwidth of the third regional bridge, and/or a second reliability measurement of the second regional bridge is better than a first reliability measurement of the first regional bridge a third reliability measurement of the third regional bridge.

Method(s) and computing component(s) or other means may further or alternatively: designate the third regional bridge as the master node when a third capacity of the third regional bridge is better than a first capacity of the first regional bridge and a second capacity of the second regional bridge, a third available bandwidth of the third regional bridge is better than a first available bandwidth of the first regional bridge a second available bandwidth of the second regional bridge, and/or a third reliability measurement of the third regional bridge is better than a first reliability measurement of the first regional bridge a second reliability measurement of the second regional bridge.

In accordance with some aspects, the first regional bridge, the second region bridge, and the third region bridge are in different geographical regions. Of course, any number of bridges for any number of regions are possible. Regions may be determined by various means, including area codes and country codes.

In accordance with some aspects, the first meta data includes the conference identifier, a first identifier of the first user, and an indication as to whether the first user is speaking, and the second meta data includes the conference identifier, a second identifier of the second user, and an indication as to whether the second user is speaking.

By way of example, one embodiment of a teleconferencing system comprises: a plurality of bridges that collectively host a teleconference, wherein the plurality of bridges includes at least a first bridge connected to a first caller of the teleconference and a second bridge connected to a second caller of the teleconference. In one implementation of the embodiment of a teleconferencing system, the teleconferencing system further comprises: a processor, wherein the processor selects the first bridge as a master node for the teleconference during a first period of time based on a first set of one or more values of a set of one or more operating parameters for each bridge in the plurality of bridges during the first period of time, and wherein the processor selects the second bridge as the master node for the teleconference during a second period of time based on a second set of one or more values of the set of one or more operating parameters for each bridge in the plurality of bridges during the second period of time.

An output from one system may cause another system to perform a method even if intervening steps occur between the output and performance of the method.

Any method step or feature disclosed herein may be expressly restricted from a claim for various reasons like achieving reduced manufacturing costs, lower power consumption, and increased processing efficiency.

The illustrative methods described herein may be implemented, performed, or otherwise controlled by suitable hardware known or future by one of ordinary skill in the art, or by firmware or software executed by computing component(s), or any combination of hardware, software and firmware. Software may be downloadable and non-downloadable at a particular system. Such software comprises a machine-implemented component that, once loaded on a machine like a computing component or a computer, changes the operation of that machine.

Systems on which methods described herein are performed may include one or more means that implement those methods. For example, such means may include computing component(s) or other hardware that, when executing instructions (e.g., embodied in software or firmware), perform any method step disclosed herein. A computing component may include, or be included within, a processor, a computing device like a computer, a controller, an integrated circuit, a “chip”, a system on a chip, a server, other programmable logic devices, other circuitry, or any combination thereof.

“Memory” may be accessible by a machine (e.g., a computing component), such that the machine can read/write information from/to the memory. Memory may be integral with or separate from the machine. Memory may include a non-transitory machine-readable medium having machine-readable program code (e.g., instructions) embodied therein that is adapted to be executed to implement each of the methods and method steps disclosed herein. Memory may include any available storage media, including removable, non-removable, volatile, and non-volatile media—e.g., integrated circuit media, magnetic storage media, optical storage media, or any other computer data storage media. As used herein, machine readable media includes all forms of machine-readable media except to the extent that such media is deemed to be non-statutory (e.g., transitory propagating signals).

Application programs may carry out aspects by receiving, converting, processing, storing, retrieving, transferring and/or exporting data, which may be stored in a hierarchical, network, relational, non-relational, object-oriented, or other data source. A data source may be a single storage device or realized by multiple (e.g., distributed) storage devices.

All of the information disclosed herein may be represented by data, and that data may be transmitted over any communication pathway using any protocol, stored on a data source, and processed by a computing component. For example, information can be represented by data that is transmitted between devices and/or components using data signals or packets. Transmission of data may be carried out using a variety of wires, cables, radio signals and infrared light beams, and an even greater variety of connectors, plugs and protocols even if not shown or explicitly described. Systems/platforms described herein may exchange information with each other (and with other systems that are not described) using any known or future communication technology, including WiFi, Bluetooth, NFC and other communication network technologies. Carrier waves may be used to transfer data and instructions through electronic, optical, air, electromagnetic, radio frequency, or other signaling media over a network using network transfer protocols, including data that is transferred in data signals. Data, instructions, commands, information, signals, bits, symbols, and chips disclosed herein may be represented by voltages, currents, electromagnetic waves, magnetic fields or particles, optical fields or particles, or any combination thereof.

Different systems/platforms disclosed herein may be geographically dispersed from one another in different regions (e.g., cities, countries), such that different method steps are performed in different regions and by different systems/platforms.

Features in system figures that are illustrated as rectangles may refer to hardware, firmware or software, each of which may comprise a component of a device. It is noted that lines linking two such features may be illustrative of data transfer between those features. Such transfer may occur directly between those features or through intermediate features even if not illustrated. Where no line connects two features, transfer of data between those features is contemplated unless otherwise stated. Thus, such lines are provided to illustrate certain aspects, but should not be interpreted as limiting.

When two things (e.g., individual components, modules each comprising multiple components, etc.) are “coupled to” each other, those two things may be directly connected together, or may be separated by one or more intervening things Thus, no direct connection is required between the two things Where an output and an input are coupled to each other, data and/or signaling sent from the output is received by the input even if the data passes through one or more intermediate things. Arrows of system diagrams in the drawings can represent couplings.

The words comprise, comprising, include, including and the like are to be construed in an inclusive sense (i.e., not limited to) as opposed to an exclusive sense (i.e., consisting only of). Words using the singular or plural number also include the plural or singular number, respectively. The words or or and, as used in the Detailed Description, cover any of the items and all of the items in a list. The words some, any and at least one refer to one or more. The term may is used herein to indicate an example, not a requirement—e.g., a thing that may perform an operation or may have a characteristic need not perform that operation or have that characteristic in each embodiment, but that thing performs that operation or has that characteristic in at least one embodiment. This disclosure is not intended to be limited to the aspects shown herein but is to be accorded the widest scope understood by a skilled artisan, including equivalents.

1. A teleconferencing system comprising:
a first regional bridge that receives a first call from a first user after the first user dials a first regional phone number, wherein the first regional bridge identifies a teleconference based on input from the first user;
a second regional bridge that receives a second call from a second user after the second user dials a second regional phone number, wherein the second regional bridge identifies the teleconference based on input from the second user; and
a communication channel formed between the first regional bridge and the second regional bridge that permits the first regional bridge and the second regional bridge to collectively host the teleconference,
wherein the communication channel exchanges first audio output and first meta data from the first regional bridge to the second regional bridge, and
wherein the communication channel exchanges second audio output and second meta data from the second regional bridge to the first regional bridge.

2. The teleconferencing system of claim 1, wherein the system further comprises:
a processor that designates one of the first and second regional bridges as a master node,
wherein the processor designates the first regional bridge as the master node when a first capacity of the first regional bridge is better than a second capacity of the second regional bridge, a first available bandwidth of the first regional bridge is better than a second available bandwidth of the second regional bridge, and/or a first reliability measurement of the first regional bridge is better than a second reliability measurement of the second regional bridge, and
wherein the processor designates the second regional bridge as the master node when a second capacity of the second regional bridge is better than a first capacity of the first regional bridge, a second available bandwidth of the second regional bridge is better than a first available bandwidth of the first regional bridge, and/or a second reliability measurement of the second regional bridge is better than a first reliability measurement of the first regional bridge.

3. The teleconferencing system of claim 1, wherein the system further comprises:
a third regional bridge that receives a third call from a third user who uses a third regional phone number, wherein the third regional bridge identifies the conference identifier based on input from the third user that identifies the conference identifier; and
an additional communication channel formed between the third regional bridge and only a selected one of the first and second regional bridges,
wherein the additional communication channel exchanges third audio output and third meta data from the third regional bridge to the selected one of the first and second regional bridges, and
wherein the additional communication channel exchanges the first and second audio output and the first and second meta data from the selected one of the first and second regional bridges to the third regional bridge.

4. The teleconferencing system of claim 3, wherein the system further comprises:
a processor that designates one of the first, second and third regional bridges as a master node in order to minimize latency of data exchange among the first, second and third bridges.

5. The teleconferencing system of claim 3, wherein the system further comprises:
a processor that designates one of the first, second and third regional bridges as a master node in order to minimize a diameter of a spanning graph based on consideration of the locations of the first, second and third bridges.

6. The teleconferencing system of claim 1, wherein the system further comprises:
a processor that designates one of the first, second and third regional bridges as a master node,
wherein the processor designates the first regional bridge as the master node when a first capacity of the first regional bridge is better than a second capacity of the second regional bridge and a third capacity of the third regional bridge, a first available bandwidth of the first regional bridge is better than a second available bandwidth of the second regional bridge a third available bandwidth of the third regional bridge, and/or a first reliability measurement of the first regional bridge is better than a second reliability measurement of the second regional bridge a third reliability measurement of the third regional bridge,
wherein the processor designates the second regional bridge as the master node when a second capacity of the second regional bridge is better than a first capacity of the first regional bridge and a third capacity of the third regional bridge, a second available bandwidth of the second regional bridge is better than a first available bandwidth of the first regional bridge a third available bandwidth of the third regional bridge, and/or a second reliability measurement of the second regional bridge is better than a first reliability measurement of the first regional bridge a third reliability measurement of the third regional bridge, and
wherein the processor designates the third regional bridge as the master node when a third capacity of the third regional bridge is better than a first capacity of the first regional bridge and a second capacity of the second regional bridge, a third available bandwidth of the third regional bridge is better than a first available bandwidth of the first regional bridge a second available bandwidth of the second regional bridge, and/or a third reliability measurement of the third regional bridge is better than a first reliability measurement of the first regional bridge a second reliability measurement of the second regional bridge.

7. The teleconferencing system of claim 1,
wherein the first meta data includes the conference identifier, a first identifier of the first user, and an indication as to whether the first user is speaking, and
wherein the second meta data includes the conference identifier, a second identifier of the second user, and an indication as to whether the second user is speaking.

8. The teleconferencing system of claim 1, wherein the first regional bridge and the second region bridge are in different geographical regions.

9. The teleconferencing system of claim 3, wherein the first regional bridge, the second region bridge, and the third region bridge are in different geographical regions.

10. A teleconferencing system comprising:
a plurality of bridges that collectively host a teleconference, wherein the plurality of bridges includes at least a first bridge connected to a first caller of the teleconference and a second bridge connected to a second caller of the teleconference.

11. The teleconferencing system of claim 7, wherein the system further comprises:
a processor,
wherein the processor selects the first bridge as a master node for the teleconference during a first period of time based on a first set of one or more values of a set of one or more operating parameters for each bridge in the plurality of bridges during the first period of time, and wherein the processor selects the second bridge as the master node for the teleconference during a second period of time based on a second set of one or more values of the set of one or more operating parameters for each bridge in the plurality of bridges during the second period of time.
